(19) United States
(12) Patent Application Publication
(10) Pub. No.: US 2022/0397243 A1
(43) Pub. Date: Dec. 15, 2022

(54) A LIFI DEVICE

(71) Applicant: SIGNIFY HOLDING B.V., Eindhoven (NL)

(72) Inventors: ANDREAS FELIX ALFRED BLUSCHKE, EINDHOVEN (NL); RIFAT ATA MUSTAFA HIKMET, EINDHOVEN (NL); KARNEKUMAR ARULANDU, BREDA (NL); TIES VAN BOMMEL, HORST (NL)

(21) Appl. No.: 17/773,762

(22) PCT Filed: Nov. 3, 2020
(86) PCT No.: PCT/EP2020/080721

§ 371 Date: May 2, 2022

(30) Foreign Application Priority Data
Nov. 5, 2019 (EP) 19207177.7

(51) Int. Cl. F21K 9/232; F21K 9/238

(52) U.S. Cl. CPC F21K 9/232; F21K 9/238; F21Y 2115/10

(57) ABSTRACT

The one or more LED filaments (110) are arranged to form an inner space. At least one of the one or more LED filaments (110) is arranged as a LiFi transmitter. The LiFi device (100) further comprises a light sensor (120) arranged within the inner space. The light sensor (120) is arranged as a LiFi receiver. The LiFi device further comprises an envelope arranged to envelope the one or more LED filaments (110) and the light sensor (120). The one or more LED filaments (110) are further arranged such that the LED filament light is directed towards the envelope.

### FIELD OF THE INVENTION

The invention relates to a LiFi device.

### BACKGROUND OF THE INVENTION

Over the past years, various types of lamps have been developed using LED filaments. An example of such lamps is retrofit lamps which make use of the infrastructure for producing incandescent lamps based on glass and replace the filament with LED. For instance, incandescent lamps have been developed comprising LED filaments. Furthermore, LED lamps have been developed comprising a LiFi transmitter or a LiFi receiver. It is nevertheless desired to produce such lamps with additional functionalities.

In US 2019/319075 techniques are described for providing an ad hoc mesh network of nodes that employ a light-based transmission protocol, such as a version of light fidelity (LiFi). The mesh network includes multiple nodes that each includes transceiver(s) for sending and receiving light-based communications. A node in the mesh network can receive a message signal sent by another node, by detecting the light modulations emitted by the sending node to transmit the message signal.

### SUMMARY OF THE INVENTION

It is an object of the present invention to overcome at least some of the above problems.

According to a first aspect, this and other objects are achieved by providing a LiFi device. The LiFi device comprises one or more LED filaments configured to emit LED filament light. The one or more LED filaments are arranged to form an inner space, wherein at least one of the one or more LED filaments is arranged as a LiFi transmitter. The LiFi device further comprises a light sensor arranged within the inner space. The light sensor is arranged as a LiFi receiver. The LiFi device further comprises an envelope arranged to envelope the one or more LED filaments and the light sensor. The one or more LED filaments are further arranged such that the LED filament light is directed towards the envelope. Thereby, substantially no LED filament light emitted by the one or more LED filaments is emitted towards the inner space.

The present LiFi device provides for decoupling of the LiFi transmitter and the LiFi receiver in the same LiFi device. By decoupling the LiFi transmitter and the LiFi receiver, a single device may be used both as a LiFi transmitter and LiFi receiver. Especially, the LiFi transmitter and the LiFi receiver of the LiFi device may be used simultaneously with a minimum of crosstalk between the LiFi transmitter and the LiFi receiver. This is since the light sensor, used as the LiFi receiver, is not affected by light emitted by the one or more LED filaments, arranged as the LiFi transmitter. Hence, a single device may be used both as a LiFi transmitter and LiFi receiver.

By a LiFi device is hereby meant a light fidelity device that utilizes light to transmit and receive data in the form of LiFi signals.

By an LED filament is hereby meant an LED filament which provides an LED filament light and comprises a plurality of light emitting diodes (LEDs) arranged in a linear array. Preferably, the LED filament has a length L and a width W, wherein L>5 W. The LED filament may be arranged in a straight configuration or in a non-straight configuration such as for example a curved configuration, a 2D/3D spiral or a helix. Preferably, the LEDs are arranged on an elongated carrier like for instance a substrate, that may be rigid (made from e.g. a polymer, glass, quartz, metal or sapphire) or flexible (e.g. made of a polymer or metal e.g. a film or foil).

In case the carrier comprises a first major surface and an opposite second major surface, the LEDs are arranged on at least one of these surfaces. The carrier may be reflective or light transmissive, such as translucent and preferably transparent.

The LED filament may comprise an encapsulant at least partly covering at least part of the plurality of LEDs. The encapsulant may also at least partly cover at least one of the first major or second major surface. The encapsulant may be a polymer material which may be flexible such as for example a silicone. Further, the LEDs may be arranged for emitting LED light e.g. of different colours or spectrums. The encapsulant may comprise a luminescent material that is configured to at least partly convert LED light into converted light. The luminescent material may be a phosphor such as an inorganic phosphor and/or quantum dots or rods. The LED filament may comprise multiple sub-filaments. The LED filament provides LED filament light. Substantially all LED filament light is directed towards the envelope such that substantially no or a little (less than 5%) direct LED filament light emitted by the one or more LED filaments is emitted towards the inner space. The LED filament light comprises light emitted by the LED filament and/or the converted LED light such as light received from other lamps.

By an inner space is hereby meant a space inside or within. For instance, by the one or more LED filaments are arranged to form an inner surface is hereby meant that the one or more LED filaments are arranged such that they form a space inside or within the one or more LED filaments.

By a light sensor is hereby meant a sensor arranged to detect light. Examples of such light sensors are photoresistors, phototransistors and photodiodes such as PIN or avalanched photodiodes.

By within is hereby meant inside. For instance, by a light sensor arranged within the inner space is hereby meant that a light sensor is arranged inside the inner space.

By an envelope is hereby meant a light exit window. The envelope is light transmissive. Preferably the envelope is translucent, more preferably the envelope is transparent. The transparent envelope is more preferred since it provides optimal sending and receiving performances. This is since the transparent envelope provide no or at least little back reflection and hence no or at least little crosstalk. The envelope may be a bulb enveloping the one or more LED filaments and the light sensor. The bulb may look similar to those of incandescent lamps providing a vintage look LiFi device. The vintage look LiFi device may also be used for lighting purposes i.e. LiFi LED lamps. This may in turn provide a new functionality to the prior vintage look LED filament lamps i.e. a vintage look LED filament lamp which is also a LiFi device.

The one or more LED filaments may be arranged as a spiral or loop around the light sensor. The spiral or the loop may comprise at least three loops. The one or more LED filaments may be arranged as a helix around the light sensor. The one or more LED filaments arranged as the spiral, helix or the loop, around the light sensor, may facilitate forming the inner space. In addition, the one or more LED filaments arranged as the spiral, helix or the loop, around the light sensor, may provide the LiFi device with various looks and may allow a more flexible design of the LiFi device. Further, by arranging the one or more LED filaments as the spiral, helix or loop, LiFi LED lamps with various looks for decorative purposes may be provided.

The one or more LED filaments may comprise an elongated carrier having a first major surface and a second major surface opposite to the first major surface. The first major surface may be facing away from the inner space. The second major surface may be facing the inner space. The one or more LED filaments may be arranged on the first major surface and no LED may be arranged on the second major surface. Thereby, the LED filament light emitted by the one or more LED filaments may be directed towards the envelope i.e. away from the light sensor. This may in turn results into a minimum of crosstalk between the LiFi transmitter and the LiFi receiver.

The one or more LED filaments may comprise a reflector configured to reflect the LED filament light in a direction away from the light sensor. It may be that the elongated carrier is reflective. For instance, the elongated carrier may be formed of a reflective material. The elongated carrier may alternatively, or in combination, be coated with a reflective layer. An example of advantages brought by the reflector may be that no light or a little light, emitted by the one or more LED filaments, may reach the light sensor arranged within the inner space. Hence, the light sensor may detect light emitted from other LiFi devices and hence the sensitivity of the present LiFi device may increase.

The LiFi device may further comprise a light concentrator arranged within the inner space and optically connected with the light sensor. The light concentrator may increase the sensitivity of the LiFi device. This is since light from substantially all directions, over substantially all angles, and larger areas may be collected. Reception range (coverage) and data throughput of a LiFi device mostly depends on the signal-to-noise ratio and the bandwidth. The signal-to-noise ratio improvement may preferably be realized by optical gain such as by lens and/or by luminescent concentrators. This is since increasing the sensors size in order to improve signal strength may deteriorate the bandwidth of the sensor due to capacitance of the sensor that is determined by the sensor area. Alternatively, increasing gain electronically e.g. by means of operational amplifiers may compromise signal to noise ratio as op-amps add noise over frequency. Therefore, optical gain may be preferred. Especially luminescent concentrators have the ability to collect photons with a large surface and direct these photons towards a smaller surface sensor and thereby increase the gain of the optical signal.

The one or more LED filaments may be arranged as a spiral, loop or helix around the light concentrator. Thereby, the light concentrator may be arranged within the inner space formed by the one or more LED filaments.

The light concentrator may be a luminescent light concentrator. A luminescent light concentrator comprises a light guide which comprises a luminescent material. The light guide is preferably transparent to provide optimal light guiding. The light guide has preferably smooth surfaces to provide best total internal reflection. A portion of light received from other lamps or luminaires may be converted by the luminescent material into converted light. A large portion of the converted light may be captured by the light guide due to total internal reflection. Converted light is wave guided via total internal reflection to the light sensor. Thereby, the light sensor may detect the light, and thus the data, received from the other lamps or luminaires.

By a luminescent light concentrator is hereby meant a transparent light guide comprising a luminescent material e.g. a polymer matrix material (e.g. PC, PMMA, PET) comprising an organic phosphor and/or quantum dots/rods.

The light concentrator may be in the form of a slab. Alternatively, or in combination, the light concentrator may be in the form of a rod. Alternatively, or in combination, the light concentrator may be in the form of a fiber. The slab, the rod or the fiber geometries may provide a large surface area a small cross section i.e. exit areas. Thereby, the light concentrator in the form of the slab, the rod or the fiber may provide an improved sensitivity. They may preferably be elongated. An end of the slab, the rod or the fiber may mechanically and/or optically be connected to the light sensor. For instance, the light sensor may be attached to one of the ends of the slab, rod or fiber light concentrator. In the case of the LiFi LED lamps, the slab, rod or fiber light concentrator may be arranged along a longitudinal direction of the lamp or a direction perpendicular to the longitudinal direction of the lamp to collect light from substantially all directions and substantially all angles. By the “longitudinal direction” of the lamp is hereby meant a direction along a neck portion of the bulb of the lamp toward a dome portion of the bulb of the lamp. For instance, when a lamp is connected to a room ceiling, a direction along the longitudinal direction of the lamp is directed vertically downwards e.g. onto a room floor.

Each of the one or more LED filaments may comprise a plurality of LEDs and a sub portion of the plurality of LEDs may be arranged as the LiFi transmitter. Thereby another sub portion of the plurality of LEDs, not being arranged as the LiFi transmitter, may be used for e.g. lighting purpose. This may in turn allow the LiFi devices or the LiFi LED lamps with various looks.

The sub portion of the plurality of LEDs arranged as the LiFi transmitter may be infrared IR, LEDs. The IR LEDs may communicate e.g. with LiFi receivers of other LiFi devices by transmitting IR light. Thereby the light communicated by the LiFi device may not be in the visible light range. The another sub portion of the plurality of LEDs, not being arranged as the LiFi transmitter, may emit visible light for lighting purposes. Thereby, the LiFi transmitter being IR LEDs may in turn prevent modulation of the visible light, provided by the another sub portion of the plurality of LEDs, if present.

The LiFi device may further comprise a modulation circuit, wherein a modulation current from the modulation circuit may be applied to LEDs of the one or more LED filaments constituting the LiFi transmitter. The modulation circuit may facilitate separating the modulation current from a constant current. Thereby, the modulation circuit may facilitate applying the modulation current to the LEDs of the one or more LED filaments constituting the LiFi transmitter. Applying the modulation current to the LEDs of the one or more LED filaments constituting the LiFi transmitter may in turn reduce a power consumption of the modulation circuit.

The LiFi receiver may further comprise a selective wavelength filter. The selective wavelength filter may be configured to transmit IR-light and to block visible light. The selective wavelength filter may be arranged at the LiFi receiver. The selective wavelength receiver may improve, a signal-to-noise ratio of the LiFi device.

The one or more LED filaments may be arranged at a distance>5 mm from the light sensor. This may further improve decoupling of the LiFi transmitter and the LiFi receiver. In other words, this may further decrease the crosstalk between the LiFi transmitter and the LiFi receiver.

According to another aspect of the present invention, a use of the LiFi device is provided for sending and receiving LiFi signals. This aspect may generally present the same or corresponding advantages as the former aspect.

A further scope of applicability of the present invention will become apparent from the detailed description given below. However, it should be understood that the detailed description and specific examples, while indicating preferred embodiments of the invention, are given by way of illustration only, since various changes and modifications within the scope of the invention will become apparent to those skilled in the art from this detailed description.

Hence, it is to be understood that this invention is not limited to the particular component parts of the device described or steps of the methods described as such device and method may vary. It is also to be understood that the terminology used herein is for purpose of describing particular embodiments only and is not intended to be limiting. It must be noted that, as used in the specification and the appended claim, the articles “a,” “an,” “the,” and “said” are intended to mean that there are one or more of the elements unless the context clearly dictates otherwise. Thus, for example, reference to “a device” or “the device” may include several devices, and the like. Furthermore, the words “comprising”, “including”, “containing” and similar wordings does not exclude other elements or steps.

### BRIEF DESCRIPTION OF THE DRAWINGS

The above and other aspects of the present invention will now be described in more detail, with reference to the appended figures showing embodiments of the invention. The figures describe LiFi devices comprised in bulbs of incandescent lamps. However, the figures should not be considered limiting the invention to the lamps; instead they are used for explaining and understanding the invention.

FIGS. 1-4 illustrate side views of four different embodiments of LED-lamps each constituting a LiFi device.

FIGS. 5-6 illustrate side views of two different embodiments of LED-lamps each constituting a LiFi device with IR LEDs as LiFi transmitters.

FIG. 7 illustrates a modulation circuit.

As illustrated in the figures, the sizes of components are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

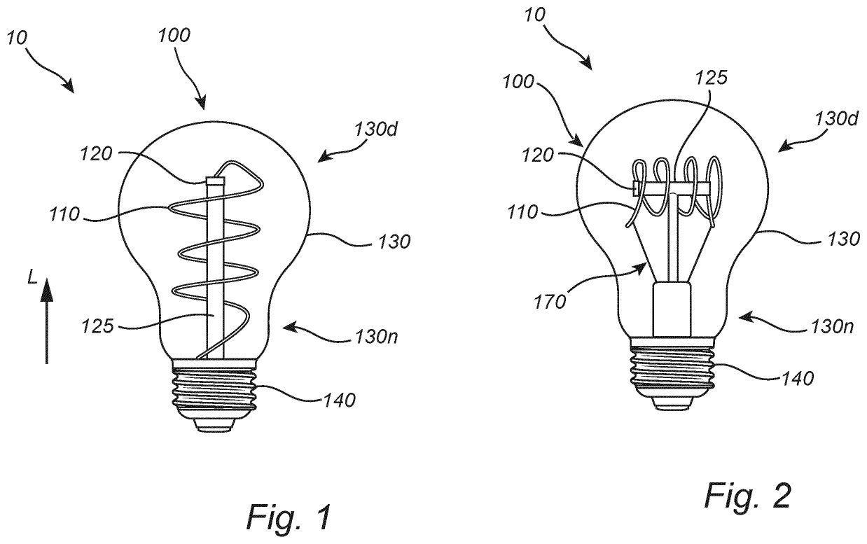

In connection with FIG. 1, a lamp 10 is illustrated. L denotes a longitudinal direction of the lamp 10. FIG. 1 shows that the lamp 10 comprises an envelop 130 in the form of a bulb 130. The bulb 130, shown in FIG. 1, has a neck portion 130n and a dome portion 130d. The bulb 130 extends from the neck portion 130n towards the dome portion 130d along the longitudinal direction L of the lamp 10. The bulb 130 shown in FIG. 1 looks similar to bulbs of the incandescent lamps. The neck portion 130n of the bulb 130 has a smaller dimension e.g. a smaller diameter with respect to the dome portion 130d. The bulb 130 may have other shapes. The bulb 130 shown in FIG. 1 is formed of glass. The bulb 130 may be formed of various materials. The bulb may be formed in a manner which per se is known in the art.

FIG. 1 further shows that the lamp 10 comprises a cap 140. The neck portion 130n of the bulb 130 is connected to the cap 140. The cap 140 may allow the lamp 10 to be safely and conveniently connected to a lamp holder. The cap 140 may comprise electronic components for providing electricity to LEDs and LiFi devices. In this case, the neck portion 130n of the bulb 130 may not be translucent.

FIG. 1 further shows that the lamp 10 comprises a LiFi device 100. The LiFi device 100 of FIG. 1 comprises one or more LED filaments 110. The one or more LED filaments 110 are configured to emit LED filament light. FIG. 1 further shows that the one or more LED filaments 110 are arranged as a helix along the longitudinal direction L of the lamp 10. The one or more LED filaments 110 are arranged to form an inner space i.e. the space inside the helix. The one or more LED filaments 110 may be arranged as a loop. The one or more LED filaments 110 may be arranged in other forms, provided that the one or more LED filaments 110 form an inner space. A typical size (S) of the one or more LED filaments 110, in the form of a helix shown in FIG. 1, may be in a range of 20 mm to 50 mm, along the longitudinal direction L of the lamp 10. A typical size of the one or more LED filaments, in the form of a helix shown in FIG. 1, may be in a range of 15 mm to 30 mm, in any direction opposite to the longitudinal direction L of the lamp 10.

Each of the one or more LED filaments 110 may comprise a plurality of LEDs. The one or more LED filaments 110 of FIG. 1 are further arranged such that the LED filament light is directed towards the envelope. In other words, the one or more LED filaments 110 of FIG. 1 are arranged to emit light outwards i.e. out from the LiFi device 100. The one or more LED filaments 110 of FIG. 1 emit no light or very little light towards the inner space. The one or more LED filaments 110 may comprises an elongated carrier having a first major surface and a second major surface opposite to the first major surface. The one or more LED filaments 110 may be arranged on the first major surface. The first major surface may face away from the inner space. The second major surface may face the inner surface. No LED may be arranged on the second major surface. For instance, the one or more LED filaments 110 may be arranged as a helix such that the first major surface comprising the plurality of LEDs may face outwards i.e. away from an inner space of the helix. In other words, the second major surface i.e. not comprising a plurality of LEDs may face towards the inner surface.

Alternatively, or in combination, the one or more LED filaments 110 may comprise a reflector. In other words, the reflector may be arranged at a surface facing the inner space. The reflector may be formed such that it may reflect light emitted by the one or more LED filaments 110 away from the inner space. In the case of having the reflector, the one or more LED filaments 110 may comprise a plurality of LEDs on all surfaces. The reflector may be formed of e.g. polished aluminium. The reflector may be applied as a metallic mirror coating or white reflective silicon. For instance, the elongated carrier may be a glass or a polymer substrate. The elongated carrier may be coated with a reflective coating such as a thin layer of Aluminium or silver, or a coating of a polymer matrix with Al₂O₃, BaSO₄, and/or TiO₂ particles, or other reflective flakes.

Still referring to FIG. 1, the one or more LED filaments 110 are arranged as a LiFi transmitter of the LiFi device 100. As mentioned above, each of the one or more LED filaments 110 may comprise a plurality of LEDs. A sub portion of the plurality of LEDs may be arranged as the LiFi transmitter. Another sub portion of the plurality of LEDs may be used for lighting purpose. For instance, the another sub portion of the plurality of LEDs may comprise LEDs emitting white light. The another sub portion of the plurality of LEDs may preferably have a color temperature in the range of 1800 to 5000 K and a color rendering index may preferably be at least 80. The another sub portion of the plurality of LEDs may have various shapes and forms for decorative purpose.

FIG. 1 further shows that the LiFi device 100 comprises a light sensor 120. FIG. 1 shows that the light sensor 120 is arranged within the inner space, formed by the one or more LED filaments 110. FIG. 1 shows that the one or more LED filaments 110 are arranged as the helix around the light sensor 120. The one or more LED filaments 110 may be arranged as a spiral or a loop around the light sensor 120. The one or more LED filaments 110 may be arranged in other forms around the light sensor 120, provided that the one or more LED filaments 110 form an inner space. The light sensor 120 may be arranged in the cap 140 or the neck portion 130n of the bulb 130. In the case of the reflector, the reflector may be configured to reflect the LED filament light in a direction away from the light sensor 120.

Still referring to FIG. 1, the light sensor 120 is arranged as a LiFi receiver of the LiFi device 100. The light sensor 120 may comprise e.g. PIN— or Avalanche photodiodes. A typical area of the light sensor 120 may be in a range of 1 mm² to 40 mm². The one or more LED filaments 110 may be arranged at a distance>5 mm from the light sensor 120.

Still referring to FIG. 1, the LiFi device 100 further comprise a light concentrator 125 arranged within the inner space formed by the one or more LED filaments 110. The light concentrator 125 may be optically connected with the light sensor 120. The light concentrator 125 may be a luminescent light concentrator 125. The light concentrator 125 may be formed of a polymer matrix material comprising an organic phosphor. The light concentrator 125 may be in the form of a slab, a rod or a fiber. The light concentrator 125 may also have an irregular shape such as a meander. FIG. 1 shows that the light concentrator 125 is in the form of a rod. A typical size of a light concentrator 125 shown in FIG. 1 may be in a range of 10 mm to 60 mm along the longitudinal direction L of the lamp 10. A typical size of the light concentrator 125 may be in a range of 2 mm to 15 mm in other directions opposite to the longitudinal direction L of the lamp 10.

The light concentrator 125 may be a luminescent light concentrator. The luminescent light concentrator 125 may have a height H. The height of the luminescent light concentrator 125 may be in a range from a half (0.5S) to a complete (1S) size of the one or more LED filaments 110 along the longitudinal direction L of the lamp. A length of the luminescent light concentrator is preferably at least 2 cm, more preferably at least 3 cm, most preferable at least 4 cm. A surface area of the luminescent light concentrator is preferably at least 3 cm², more preferably at least 5 cm², most preferably at least 7 cm².

Still referring to FIG. 1, the light concentrator 125 may be optically connected to the light sensor 120. For instance, the light sensor 120 may be arranged at one of the ends of the light concentrator 125. FIG. 1 shows that the light sensor 120 is arranged at an upper end of the light concentrator 125 i.e. the end of the light concentrator 125 close to the dome portion 130d of the lamp 100. The light sensor 120 may alternatively be arranged at a lower end of the light concentrator 125 i.e. the end of the light concentrator 125 close to the neck portion 130n of the lamp 100.

In connection with FIG. 2, another lamp 10 is shown. FIG. 2 illustrates that the one or more LED filaments 110 and the light concentrator 125 extend in a direction opposite to the longitudinal direction L of the lamp 10. In FIG. 2, the light sensor 120 is attached to a left end of the light concentrator 125. The LiFi device of FIG. 2 is connected to the neck portion 130n of the lamp 10 by a supporting means 170.

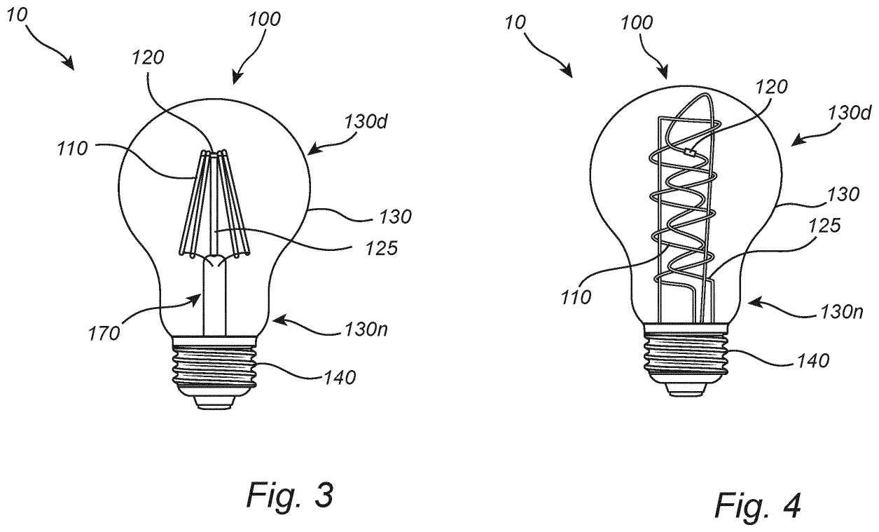

In connection with FIG. 3, yet another lamp 10 is shown. The one or more LED filaments 110 of FIG. 3 are arranged like ribs of an umbrella around the light concentrator 125. The LiFi device of FIG. 3 is connected to the neck portion 130n of the lamp 10 by a supporting means 170.

In connection with FIG. 4, yet another lamp 10 is shown. The one or more LED filaments 110 of FIG. 4 have similar shape and form of the one or more LED filaments 110 of FIG. 1. The light concentrator 125 of FIG. 4 is arranged in the form of a meander within the inner space. FIG. 4 shows that the light sensor 120 is comprised in an upper portion of the light concentrator 125. The light sensor 120 may be comprised in a middle portion or a lower portion of the light concentrator 125.

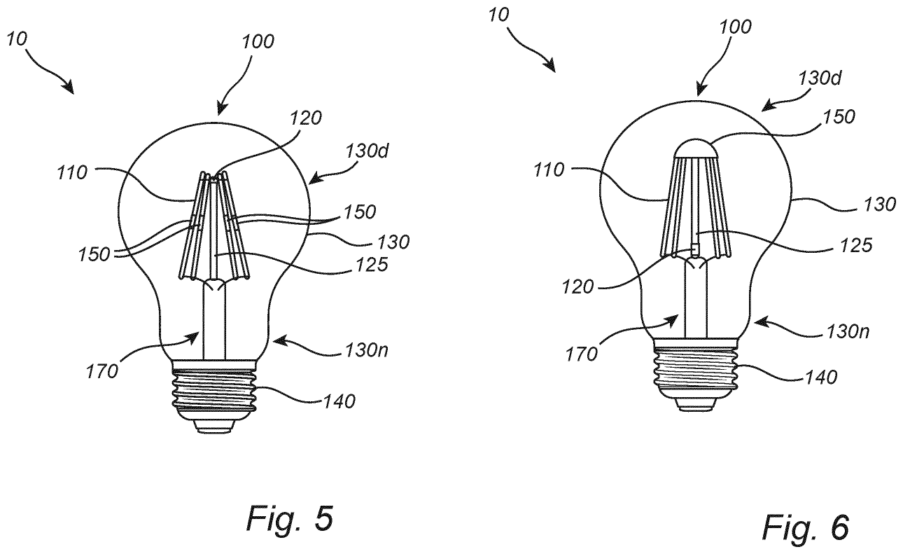

In connection with FIG. 5, a lamp 10 is shown wherein a sub portion of the plurality of LEDs arranged as the LiFi transmitter are infrared, IR, LEDs 150. The one or more LED filaments 110 of FIG. 5 are arranged like ribs of an umbrella around the light concentrator 125. FIG. 5 shows that the IR LEDs are 150 arranged in the one or more LED filaments 110 i.e. the IR LEDs 150 are arranged in middle portions of the ribs of the umbrella around the light concentrator 125. The IR LEDs 150 may be arranged in lower or upper portions of the ribs of the umbrella around the light concentrator 125. The LiFi device of FIG. 5 is connected to the neck portion 130n of the lamp 10 by a supporting means 170.

In connection with FIG. 6, another lamp 10 is shown wherein a sub portion of the plurality of LEDs arranged as the LiFi transmitter are infrared, IR, LEDs 150. The one or more LED filaments 110 of FIG. 6 are arranged like ribs of an umbrella around the light concentrator 125. FIG. 6 shows that the IR LEDs 150 are arranged above, along the longitudinal direction (L) of the lamp 10, and in contact with the one or more LED filaments 110. The LiFi device of FIG. 6 is connected to the neck portion 130n of the lamp 10 by a supporting means 170.

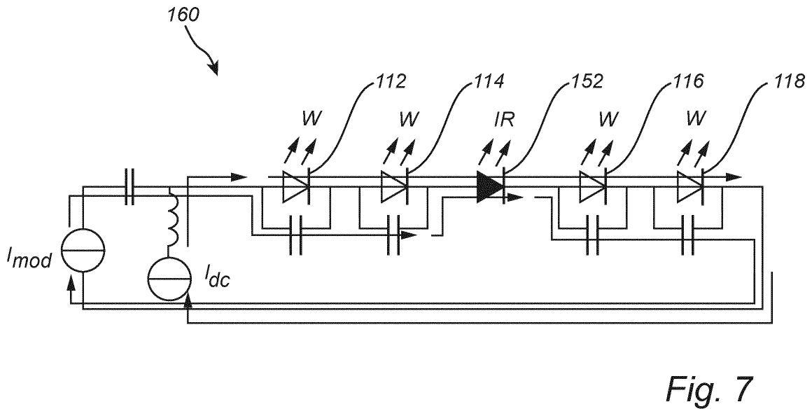

In connection with FIG. 7, the LiFi device 100 may further comprise a modulation circuit 160. The modulation circuit 160, shown by I_{mod}, capacitors and inductors in FIG. 7, may separate the modulation current form a constant current shown by I_{dc} in FIG. 7. FIG. 7 shows that the modulation current has been bypassed by means of parallel capacitors on a plurality of LEDs 112, 114, 116, 118 providing visible light. Thereby the constant current has been applied to the plurality of LEDs 112, 114, 116, 118. FIG. 7 further shows that the modulation current has been applied to an IR LED 152. The IR LED 152 may be one of the one or more LED filaments constituting the LiFi transmitter. The modulation circuit 160 may be comprised in a LiFi device 100 or a lamp 10 having the IR LEDs as the LiFi transmitter such as the lamps shown in FIGS. 5 and 6.

The LiFi device 100 may further comprise a selective wavelength filter. The selective wavelength filter may be configured to transmit IR-light and to block visible light. The selective wavelength filter may be a sensor sensitive to a certain wavelength range such as IR wavelength range e.g. bandpass, edgepass, dichroic filters or even beam-split filters.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. A LiFi device (100) comprising:
one or more LED filaments (110) configured to emit LED filament light, wherein the one or more LED filaments (110) are arranged to form an inner space, wherein at least one of the one or more LED filaments (110) is arranged as a LiFi transmitter,
a light sensor (120) arranged within the inner space, wherein the light sensor (120) is arranged as a LiFi receiver,
an envelope arranged to envelope the one or more LED filaments (110) and the light sensor (120),
wherein the one or more LED filaments (110) are further arranged such that the LED filament light is directed towards the envelope, and
wherein the LiFi device (100) is further comprising a light concentrator (125) arranged within the inner space and optically connected with the light sensor (120).

2. The LiFi device (100) according to claim 1, wherein the one or more LED filaments (110) are arranged as a spiral or loop around the light sensor (120).

3. The LiFi device (100) according to claim 1 or 2, wherein the one or more LED filaments (110) comprises an elongated carrier having a first major surface and a second major surface opposite to the first major surface, wherein the one or more LED filaments (110) are arranged on the first major surface and no LED is arranged on the second major surface, and wherein the first major surface is facing away from the inner space.

4. The LiFi device (100) according to any one of claims 1-3, wherein the one or more LED filaments (110) comprises a reflector configured to reflect the LED filament light in a direction away from the light sensor.

5. The LiFi device (100) according to claim 4, wherein the one or more LED filaments (110) are arranged as a spiral or loop around the light concentrator (125).

6. The LiFi device (100) according to claim 4 or 5, wherein the light concentrator (125) is a luminescent light concentrator.

7. The LiFi device (100) according to any one of claims 4-6, wherein the light concentrator (125) is in the form of a slab, a rod or a fiber.

8. The LiFi device (100) according to any one of claims 1-7, wherein each of the one or more LED filaments (110) comprises a plurality of LEDs and a sub portion of the plurality of LEDs are arranged as the LiFi transmitter.

9. The LiFi device (100) according to claim 8, wherein the sub portion of the plurality of LEDs arranged as the LiFi transmitter are infrared, IR, LEDs (150).

10. The LiFi device (100) according to any one of claims 1-9, further comprising a modulation circuit (160), wherein a modulation current from the modulation circuit (160) is applied to LEDs of the one or more LED filaments (110) constituting the LiFi transmitter.

11. The LiFi device (100) according to any one of claims 1-10, wherein the LiFi receiver further comprises a selective wavelength filter.

12. The LiFi device (100) according to claim 11, wherein the selective wavelength filter is configured to transmit IR-light and to block visible light.

13. The LiFi device (100) according to any one of claims 1-12, wherein the one or more LED filaments (110) are arranged at a distance>5 mm from the light sensor (120).

14. Use of the LiFi device (100) according to any one of claims 1-13, for sending and receiving LiFi signals.
